(19) United States
(12) Patent Application Publication
(10) Pub. No.: US 2025/0331678 A1
(43) Pub. Date: Oct. 30, 2025

(54) Cooker Rack Convenient for Accommodating Cookware and Cooker

(71) Applicant: NINGBO ZHAOFENG COOKER UNITS CO., LTD, Ningbo (CN)

(72) Inventor: Zhaowei Li, Ningbo (CN)

(21) Appl. No.: 18/674,150

(22) Filed: May 24, 2024

(30) Foreign Application Priority Data
Apr. 29, 2024 (CN) 202420926805.8

(51) Int. Cl. A47J 36/34

(52) U.S. Cl. CPC A47J 36/34

(57) ABSTRACT

Disclosed is a cooker rack convenient for accommodating cookware and a cooker. When the cookware is not placed into a support limiting frame, a limiting block is positioned outside a peripheral outer side of the support limiting frame. When the cookware is placed into the support limiting frame, the limiting block moves relative to a cooker rack body until the limiting block is abutted against an outer wall of the cookware, thus ensuring no interference between the cookware and the limiting block when the cookware is vertically placed into the support limiting frame, a user can place the cookware into the support limiting frame more quickly, the operation complexity is reduced, the cooking efficiency and the operation convenience are improved, the food spilling risk is reduced, and meanwhile, the operation safety and convenience are improved.

### CROSS REFERENCE TO RELATED APPLICATIONS

The present application claims the benefit of Chinese Patent Application No. 2024209268058 filed on Apr. 29, 2024, the contents of which are incorporated herein by reference in their entirety.

### TECHNICAL FIELD

The disclosure relates to the technical field of a cooker, and particularly relates to a cooker rack convenient for accommodating cookware and a cooker.

### BACKGROUND

In a commercial use cooker, cookware is generally big, a cooker rack needs to be provided with a limiting structure to ensure the stable accommodation of the cookware. However, the position of an existing limiting structure is fixed, so that the cookware needs to be firstly inclined to avoid the limiting structure when being placed, then, the position of the cookware needs to be adjusted so that the side wall of the cookware is in contact with the limiting structure to stabilize its position, the operation difficulty is increased, the cooking efficiency is reduced, and additionally, when a large soup pot is used, soup spilling may easily occur. Particularly, under the condition that the cookware is fully filled with hot soup, safety accidents such as scald injury may easily occur due to careless operation, and meanwhile, food waste may be caused.

### SUMMARY

In order to solve at least one aspect of the above problems, the disclosure firstly provides a cooker rack convenient for accommodating cookware. The cooker rack includes a cooker rack body and a limiting assembly movably connected to the cooker rack body, the cooker rack body includes a support limiting frame disposed for accommodating the cookware, and the limiting assembly includes a limiting block abutted against an outer wall of the cookware; and when the cookware is not placed into the support limiting frame, the limiting block is positioned outside a peripheral outer side of the support limiting frame, and when the cookware is placed into the support limiting frame, the limiting block moves relative to the cooker rack body until the limiting block is abutted against an outer wall of the cookware.

Optionally, the limiting assembly includes an installing case and warping plates, the installing case and the warping plates are connected to each other, the installing case is hinged to the cooker rack body, the limiting block is installed on the installing case, one end of each of the warping plates is connected to the installing case, the other end of each of the warping plates is a suspended end, and the suspended end extends into the support limiting frame; and when the cookware is placed into the support limiting frame, the bottom of the cookware is abutted against the suspended end to make the suspended end rotate downwards, the warping plates drive the installing case to rotate relative to the cooker rack body, and the installing case drives the limiting block to synchronously move until the limiting block is abutted against the outer wall of the cookware.

Optionally, the limiting assembly further includes a hinge, the hinge includes a first hinge leaf and a second hinge leaf, the first hinge leaf and a second hinge leaf are hinged to each other, the first hinge leaf is connected to the installing case, and the second hinge leaf is connected to the cooker rack body.

Optionally, the second hinge leaf is detachably connected to the cooker rack body.

Optionally, the limiting block is slidably connected to the installing case, a second reset member is disposed between the limiting block and the installing case, and two ends of the second reset member are respectively connected to the limiting block and the installing case.

Optionally, each of the suspended ends is provided with an abutting plate abutted against the bottom of the cookware.

Optionally, first reset members are disposed in the installing case, and two ends of the first reset members are respectively connected to the installing case and the cooker rack body.

Optionally, the quantity of the first reset members is two, and the two first reset members are disposed at an interval.

Optionally, the cooker rack body is connected to first screws, one end of each of the first reset members is connected to the cooker rack body through the corresponding first screw, and the other end of each of the first reset members is abutted against the installing case.

Compared with the prior art, the cooker rack convenient for accommodating cookware according to the disclosure has the advantages that the limiting block is movable relative to the cooker rack body, thus ensuring no interference between the cookware and the limiting block when the cookware is vertically placed into the support limiting frame, so that a user can place the cookware into the support limiting frame more quickly, the cookware is enabled to be correctly placed, the operation complexity is reduced, and the cooking efficiency and operation convenience are improved. Additionally, the cookware can be vertically placed into the support limiting frame, the food spilling or potential safety hazards caused by cookware inclination can be effectively avoided, the cookware is enabled to keep stable in the accommodating process, the food spilling risk is reduced, and meanwhile, the operation safety and convenience are improved.

Additionally, the disclosure provides a cooker including the cooker rack convenient for accommodating cookware.

Compared with the prior art, the cooker in the disclosure has the same advantages as the cooker rack convenient for accommodating cookware, so it is not repeated.

### BRIEF DESCRIPTION OF FIGURES

FIG. 1 is a structure diagram when a cookware is placed into a cooker according to an embodiment of the disclosure;

FIG. 2 is a structure diagram I when the cookware is not placed into a cooker according to an embodiment of the disclosure;

FIG. 3 is a structure diagram II when the cookware is not placed into a cooker according to an embodiment of the disclosure;

FIG. 4 is a local structure diagram when the cookware is not placed into a cooker rack according to an embodiment of the disclosure;

FIG. 5 is an enlarged view of a portion A in FIG. 4;

FIG. 6 is a local structure diagram when the cookware is placed into a cooker rack according to an embodiment of the disclosure; and

FIG. 7 is an exploded view when the cookware is not placed into a cooker rack according to an embodiment of the disclosure.

### IN THE FIGURES

1 denotes a cooker rack body, 11 denotes a support limiting frame, 12 denotes a first screw, 13 denotes a second screw, 2 denotes a limiting assembly, 21 denotes a limiting block, 22 denotes an installing case, 23 denotes a warping plate, 231 denotes a suspended end, 232 denotes an abutting plate, 24 denotes a hinge, 241 denotes a first hinge leaf, 242 denotes a second hinge leaf, 25 denotes a first reset member, 26 denotes a second reset member, and 3 denotes cookware.

### DETAILED DESCRIPTION

In order to make objectives, features and advantages of the disclosure more apparent and easier to understand, specific embodiments of the disclosure will be described in further detail with reference to the accompanying drawings of the disclosure.

In the descriptions of the disclosure, it should be understood that terms “upper”, “lower”, etc. for indicating orientations or position relationships are based on the orientations or position relationships when a product is normally used.

Terms “first” and “second” are only used for description purposes, and cannot be understood as indicating or implying relative importance or impliedly indicating the quantity of the indicated technical features. Therefore, features defining “first” and “second” may explicitly or implicitly include one or more such features.

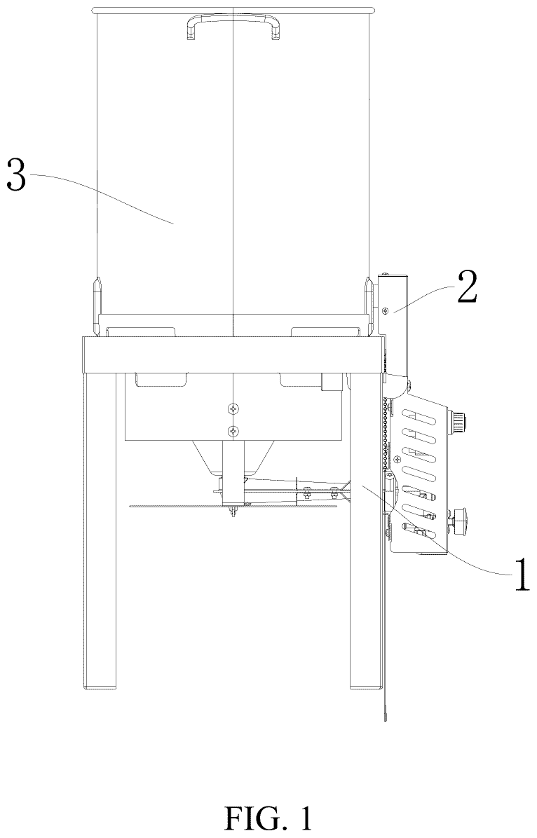

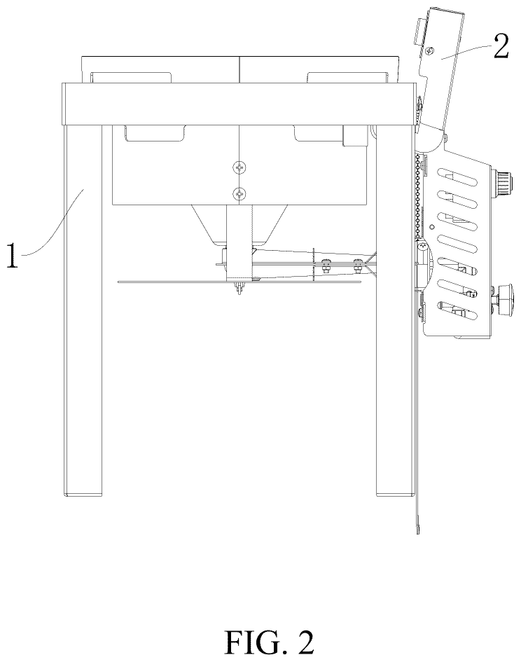

An embodiment of the disclosure provides a cooker rack convenient for accommodating cookware, in combination with FIG. 1 to FIG. 6, including a cooker rack body 1 and a limiting assembly 2 movably connected to the cooker rack body 1. The cooker rack body 1 includes a support limiting frame 11 disposed for accommodating the cookware 3, and the limiting assembly 2 includes a limiting block 21 abutted against an outer wall of the cookware 3. When the cookware 3 is not placed into the support limiting frame 11, the limiting block 21 is positioned outside a peripheral outer side of the support limiting frame 11, and when the cookware 3 is placed into the support limiting frame 11, the limiting block 21 moves relative to the cooker rack body 1 until the limiting block 21 is abutted against an outer wall of the cookware 3.

The support limiting frame 11 is a region for supporting and accommodating the cookware 3. The limiting assembly 2 is configured to ensure the accommodation stability and safety of the cookware 3. The limiting block 21 is in contact with the outer wall of the cookware 3 to achieve an effect of limiting and positioning the cookware 3. The limiting assembly 2 may be movably connected to the cooker rack body 1 in a manner of hinging connection or sliding connection. When the cookware 3 is not placed into the support limiting frame 11, the limiting block 21 is positioned outside the peripheral outer side of the support limiting frame 11, the accommodation of the cookware 3 is not influenced, and the cookware 3 may be conveniently placed vertically into the support limiting frame 11 in a subsequent process. When the cookware 3 is placed into the support limiting frame 11, the limiting block 21 may move relative to the cooker rack body 1 until the limiting block 21 is abutted against the outer wall of the cookware 3. Through the abutting of the limiting block 21 with the outer wall of the cookware 3, the accommodation stability of the cookware 3 is ensured, unnecessary shaking and movement are avoided, and the safety is improved.

According to the cooker rack convenient for accommodating cookware in this embodiment, the limiting block 21 is movable relative to the cooker rack body 1, the cookware 3 is enabled not to generate interference with the limiting block 21 when being vertically placed into the support limiting frame 11, so that a user can place the cookware 3 into the support limiting frame 11 more quickly, the cookware 3 may be correctly placed, the operation complexity is reduced, and the cooking efficiency and the operation convenience are improved. Additionally, the cookware 3 may be vertically placed into the support limiting frame, so that the food spilling or potential safety hazards caused by cookware 3 inclination can be effectively avoided, the cookware 3 is enabled to keep stable in the accommodating process, the food spilling risk is reduced, and meanwhile, the operation safety and convenience are improved.

Optionally, in combination with FIG. 1 to FIG. 7, the limiting assembly 2 includes an installing case 22 and warping plates 23, the installing case and the warping plates are connected to each other, the installing case 22 is hinged to the cooker rack body 1, the limiting block 21 is installed on the installing case 22, one end of each of the warping plates 23 is connected to installing case 22, the other end of each of the warping plates 23 is a suspended end 231, and the suspended end 231 extends into the support limiting frame 11. When the cookware 3 is placed into the support limiting frame 11, the bottom of the cookware 3 is abutted against the suspended end 231 to make the suspended end 231 rotate downwards, the warping plates 23 drive the installing case 22 to rotate relative to the cooker rack body 1, and the installing case 22 drives the limiting block 21 to synchronously move until the limiting block 21 is abutted against the outer wall of the cookware 3. The cookware 3 is enabled to be stably placed into the support limiting frame 11, the movement or inclination rick by accident is reduced, and the safety and reliability in the operation process are improved. The quantity of the warping plates 23 is two, the two warping plates are fixedly connected to two sides of the installing case 22 respectively, the stability and balance of the cooker rack structure are ensured, so that the weight of the cookware 3 can be uniformly distributed on the installing case 22, and the single pressure of a load bearing point is reduced.

The lower end of the installing case 22 is hinged to the cooker rack body 1. The limiting block 21 is installed on the upper end of the installing case 22. One end of each of the warping plates 23 is connected and fixed to the lower end of the installing case 22, so that the structure is more stable and simpler, and the operation flexibility is also realized. According to this embodiment, through the linkage of the warping plates 23 and the installing case 22, the limiting block 21 can precisely move to a position where the limiting block abuts against the outer wall of the cookware 3, the stable accommodation of the cookware 3 is enabled, the sliding or inclination is avoided, and the use safety and stability are improved. When a user places the cookware 3, the bottom of the cookware 3 only needs to be placed into the support limiting frame 11 to be in contact with the suspended ends 231 of the warping plates 23, and the limiting block 21 may automatically move to a correct position without further adjustment, so that the operation steps are simplified, and the use convenience is improved. Additionally, such a design may adapt to cookware 3 in different shapes and sizes, through automatic adjustment of the warping plates 23 and the limiting blocks 21, the effective support and positioning on various kinds of cookware 3 may be ensured, and the universality and flexibility of the cooker rack are improved.

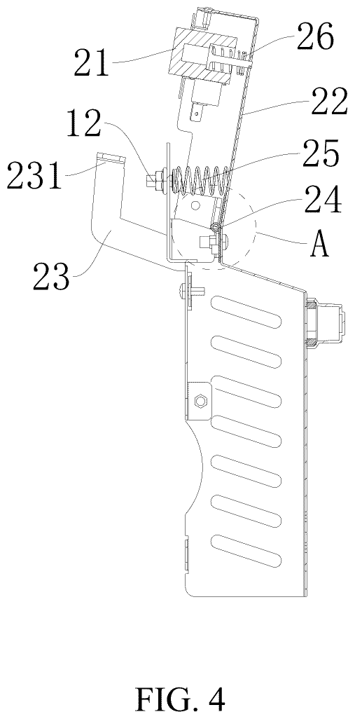

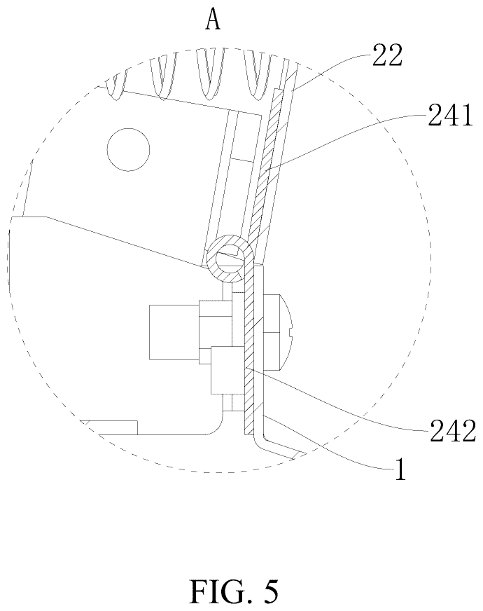

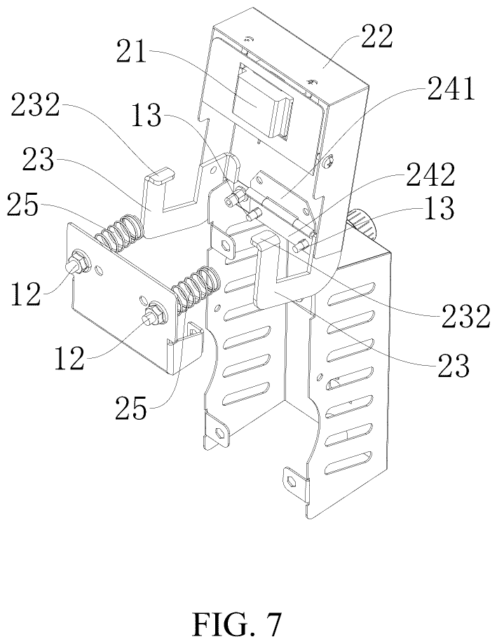

Optionally, in combination with FIG. 4, FIG. 5 and FIG. 7, the limiting assembly 2 further includes a hinge 24, the hinge 24 includes a first hinge leaf 241 and a second hinge leaf 242, the first hinge leaf and the second hinge leaf are hinged to each other, the first hinge leaf 241 is connected to the installing case 22, and the second hinge leaf 242 is connected to the cooker rack body 1. Through the design of the hinge 24, the installing case 22 and the cooker rack body 1 can rotate or swing relatively freely without being disconnected from each other. When the cookware 3 is placed into the support limiting frame 11, the warping plates 23 move to drive the installing case 22 to do relative movement, the installing case 22 may rotate relative to the cooker rack body 1 through the hinging connection of the hinge 24, and meanwhile, the stable connection is maintained. The first hinge leaf 241 is connected to the installing case 22, and may move along with the movement of the installing case 22, and the adjustment and positioning of the limiting block 21 are driven. The second hinge leaf 242 is connected to the cooker rack body 1, and the integral stability and supporting performance of the cooker rack are ensured.

In this embodiment, through the design of the hinge 24, the installing case 22 can rotate or move relatively freely, the position of the limiting block 21 may be flexibly adjusted to ensure the abutting with the outer wall of the cookware 3 in different sizes and shapes, and the accommodation precision and convenience of the cookware 3 are improved. Additionally, the connection of the hinge 24 is stable, the pressure and swinging in the placing process of the cookware 3 may be born, the stability and durability of the cooker rack are ensured, and the service life is prolonged. When the user places the cookware 3, through the hinging connection of the hinge 24, adjustment may be automatically performed to reach a proper angle and position without additional operation, so that the operation convenience and efficiency are improved. Additionally, through the design of the hinge 24, the integral structure is more compact and simpler, and a small space is occupied.

Optionally, in combination with FIG. 7, the second hinge leaf 242 is detachably connected to cooker rack body 1. The second hinge leaf 242 and the cooker rack body 1 are preferably connected detachably through second screws 13. Through the detachable connection design, the limiting assembly 2 may be separated from the cooker rack body 1, the package and transportation may be convenient, and the assembly and dismounting operations may be simple.

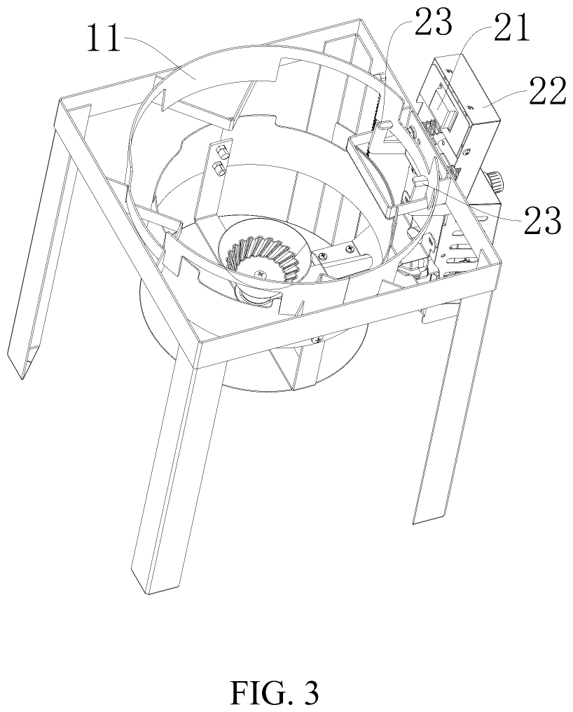

Optionally, in combination with FIG. 3 to FIG. 7, first reset members 25 are disposed in the installing case 22, and two ends of the first reset members 25 are respectively connected to the installing case 22 and the cooker rack body 1. The installing case 22 is configured to connect the limiting block 21 and accommodate the first reset members 25, and the first reset members 25 use compressed springs. When the cookware 3 is placed into the support limiting frame 11, the weight of the cookware 3 may be exerted onto the suspended ends 231 of the warping plates 23, so that the warping plates 23 drive the installing case 22 to rotate and compress the first reset members 25 until the limiting blocks 21 is abutted against the outer wall of the cookware 3. After the cookware 3 is moved away, the installing case 22 rotates to be reset under the effect of the spring force of the first reset members 25, the warping plates 23 are driven to be synchronously reset to an initial position to do a preparation for waiting for accommodating next cookware 3.

Due to the design of the first reset members 25 in this embodiment, the cooker rack has an automatic reset function. The cooker rack may automatically recover the initial state for the use for a next time after the cookware 3 is moved away without use's intervention, and the use convenience and efficiency are improved.

Optionally, in combination with FIG. 3 and FIG. 7, the quantity of the first reset members 25 is two, the two first reset members 25 are disposed at an interval. Through the design of the two first reset members 25, more uniform reset force and stability may be provided, the limiting assembly 2 is enabled to accurately return to the original position, the influence on the cooker rack stability caused by nonuniform or excessive force of a single reset member is avoided, a single-point failure risk may also be reduced, even if one of the first reset members 25 fails, the other of the first reset members 25 may still normally work, and the service life of the cooker rack is prolonged.

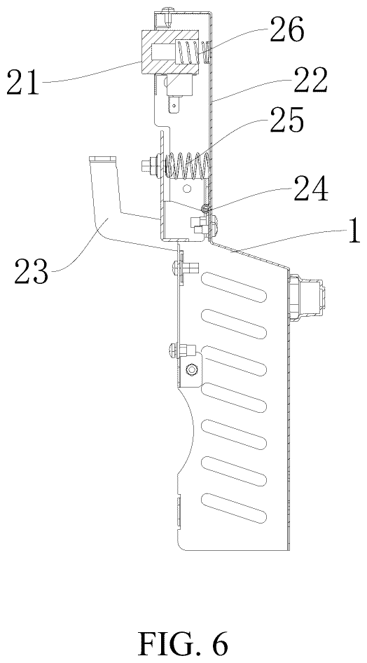

Optionally, in combination with FIG. 4, FIG. 6 and FIG. 7, the cooker rack body 1 is connected to the first screws 12, one end of each of the first reset members 25 is connected to the cooker rack body 1 through the corresponding first screw 12, and the other end of each of the first reset members 25 is abutted against the installing case 22. One end of each of the first reset members 25 is fixed onto the cooker rack body 1 through the corresponding first screw 12, so that the first reset members 25 are enabled to be firmly connected to the cooker rack body 1. The first reset members 25 can realize the automatic reset of the installing case 22 through their reset force after the cookware 3 is moved away, so that the use convenience and efficiency are improved. The other end of each of the first reset members 25 is abutted against the installing case 22. The structure is simple and reliable.

Optionally, in combination with FIG. 4 and FIG. 6, the limiting block 21 is slidably connected to the installing case 22, a second reset member 26 is disposed between the limiting block 21 and the installing case 22, and two ends of the second reset member 26 are respectively connected to the limiting block 21 and the installing case 22. The limiting block 21 is slidably connected to the installing case 22, so that the cooker rack is suitable for the cookware 3 in different shapes and sizes, and certain universality and flexibility are realized. The second reset member 26 is preferably a compressed spring, the second reset member 26 is positioned between the limiting block 21 and the installing case 22, the limiting block 21 is enabled to be tightly abutted against the outer wall of the cookware 3 under the effect of the spring reset force, and the accommodation stability and safety of the cookware 3 are ensured.

Optionally, in combination with FIG. 7, each of the suspended ends 231 is provided with an abutting plate 232 abutted against the bottom of the cookware 3. The abutting plate 232 is designed into a plane in contact with the bottom of the cookware 3 to increase the contact area of the suspended end 231 with the bottom of the cookware 3, the bottom of the cookware 3 is enabled to be stably abutted against the warping plate 23, this contact point is a movement triggering point of the warping plate 23, and the warping plate 23 may be triggered to move downwards through the abutting with the bottom of the cookware 3, so that the installing case 22 drives the limiting block 21 to move together until the limiting block 21 is abutted against the outer wall of the cookware 3.

Another embodiment of the disclosure provides a cooker including the cooker rack convenient for accommodating cookware.

According to the cooker in this embodiment, the limiting block 21 is movable relative to the cooker rack body 1, the cookware 3 is enabled not to generate interference with the limiting block 21 when being vertically placed into the support limiting frame 11, so that the user may place the cookware 3 into the support limiting frame 11 morequickly, the cookware 3 is enabled to be correctly placed, the operation complexity is reduced, and the cooking efficiency and operation convenience are improved. Additionally, the cookware 3 may be vertically placed into the support limiting frame, the food spilling or potential safety hazards caused by cookware 3 inclination can be effectively avoided, the cookware 3 is enabled to keep stable in the accommodating process, the food spilling risk is reduced, and at meanwhile, the operation safety and convenience are improved.

While various aspects and embodiments have been disclosed herein, the protection scope of the disclosure is not limited to these aspects and embodiments. Those skilled in the art may do various variations and modifications on the promise of not departing from the spirits and scope of the disclosure. These variations and modifications all fall within the protection scope of the disclosure.

What is claimed is:

1. A cooker rack convenient for accommodating cookware, comprising a cooker rack body (1) and a limiting assembly (2) movably connected to the cooker rack body (1), wherein the cooker rack body (1) comprises a support limiting frame (11) disposed for accommodating the cookware (3), and the limiting assembly (2) comprises a limiting block (21) abutted against an outer wall of the cookware (3); and when the cookware (3) is not placed into the support limiting frame (11), the limiting block (21) is positioned outside a peripheral outer side of the support limiting frame (11), and when the cookware (3) is placed into the support limiting frame (11), the limiting block (21) moves relative to the cooker rack body (1) until the limiting block (21) is abutted against an outer wall of the cookware (3).

2. The cooker rack convenient for accommodating cookware according to claim 1, wherein the limiting assembly (2) comprises an installing case (22) and warping plates (23), the installing case and the warping plates are connected to each other, the installing case (22) is hinged to the cooker rack body (1), the limiting block (21) is installed on the installing case (22), one end of each of the warping plates (23) is connected to the installing case (22), the other end of each of the warping plates (23) is a suspended end (231), and the suspended end (231) extends into the support limiting frame (11); and when the cookware (3) is placed into the support limiting frame (11), the bottom of the cookware (3) is abutted against the suspended end (231) to make the suspended end (231) rotate downwards, the warping plates (23) drive the installing case (22) to rotate relative to the cooker rack body (1), and the installing case (22) drives the limiting block (21) to synchronously move until the limiting block (21) is abutted against the outer wall of the cookware (3).

3. The cooker rack convenient for accommodating cookware according to claim 2, wherein the limiting assembly (2) further comprises a hinge (24), the hinge (24) comprises a first hinge leaf (241) and a second hinge leaf (242), the first hinge leaf and a second hinge leaf are hinged to each other, the first hinge leaf (241) is connected to the installing case (22), and the second hinge leaf (242) is connected to the cooker rack body (1).

4. The cooker rack convenient for accommodating cookware according to claim 3, wherein the second hinge leaf (242) is detachably connected to the cooker rack body (1).

5. The cooker rack convenient for accommodating cookware according to claim 2, wherein the limiting block (21) is slidably connected to the installing case (22), a second reset member (26) is disposed between the limiting block (21) and the installing case (22), and two ends of the second reset member (26) are respectively connected to the limiting block (21) and the installing case (22).

6. The cooker rack convenient for accommodating cookware according to claim 2, wherein each of the suspended ends (231) is provided with an abutting plate (232) abutted against the bottom of the cookware (3).

7. The cooker rack convenient for accommodating cookware according to claim 2, wherein first reset members (25) are disposed in the installing case (22), and two ends of the first reset members (25) are respectively connected to the installing case (22) and the cooker rack body (1).

8. The cooker rack convenient for accommodating cookware according to claim 3, wherein first reset members (25) are disposed in the installing case (22), and two ends of the first reset members (25) are respectively connected to the installing case (22) and the cooker rack body (1).

9. The cooker rack convenient for accommodating cookware according to claim 4, wherein first reset members (25) are disposed in the installing case (22), and two ends of the first reset members (25) are respectively connected to the installing case (22) and the cooker rack body (1).

10. The cooker rack convenient for accommodating cookware according to claim 5, wherein first reset members (25) are disposed in the installing case (22), and two ends of the first reset members (25) are respectively connected to the installing case (22) and the cooker rack body (1).

11. The cooker rack convenient for accommodating cookware according to claim 6, wherein first reset members (25) are disposed in the installing case (22), and two ends of the first reset members (25) are respectively connected to the installing case (22) and the cooker rack body (1).

12. The cooker rack convenient for accommodating cookware according to claim 7, wherein the quantity of the first reset members (25) is two, and the two first reset members (25) are disposed at an interval.

13. The cooker rack convenient for accommodating cookware according to claim 7, wherein the cooker rack body (1) is connected to first screws (12), one end of each of the first reset members (25) is connected to the cooker rack body (1) through the corresponding first screw (12), and the other end of each of the first reset members (25) is abutted against the installing case (22).

14. The cooker rack convenient for accommodating cookware according to claim 8, wherein the quantity of the first reset members (25) is two, and the two first reset members (25) are disposed at an interval.

15. The cooker rack convenient for accommodating cookware according to claim 8, wherein the cooker rack body (1) is connected to first screws (12), one end of each of the first reset members (25) is connected to the cooker rack body (1) through the corresponding first screw (12), and the other end of each of the first reset members (25) is abutted against the installing case (22).

16. The cooker rack convenient for accommodating cookware according to claim 9, wherein the quantity of the first reset members (25) is two, and the two first reset members (25) are disposed at an interval.

17. The cooker rack convenient for accommodating cookware according to claim 9, wherein the cooker rack body (1) is connected to first screws (12), one end of each of the first reset members (25) is connected to the cooker rack body (1) through the corresponding first screw (12), and the other end of each of the first reset members (25) is abutted against the installing case (22).

18. The cooker rack convenient for accommodating cookware according to claim 10, wherein the quantity of the first reset members (25) is two, and the two first reset members (25) are disposed at an interval.

19. The cooker rack convenient for accommodating cookware according to claim 10, wherein the cooker rack body (1) is connected to first screws (12), one end of each of the first reset members (25) is connected to the cooker rack body (1) through the corresponding first screw (12), and the other end of each of the first reset members (25) is abutted against the installing case (22).

20. A cooker, comprising the cooker rack convenient for accommodating cookware according to claim 1.
